(19) United States
(12) Patent Application Publication
(10) Pub. No.: US 2023/0261194 A1
(43) Pub. Date: Aug. 17, 2023

(54) BATTERY INCLUDING A THICK CATHODE AND A METHOD FOR FORMING THE THICK CATHODE

(71) Applicant: GM GLOBAL TECHNOLOGY OPERATIONS LLC, Detroit, MI (US)

(72) Inventors: Nicole D. Ellison, Southfield, MI (US); Xiaosong Huang, Novi, MI (US)

(73) Assignee: GM GLOBAL TECHNOLOGY OPERATIONS LLC, Detroit, MI (US)

(21) Appl. No.: 17/674,235

(22) Filed: Feb. 17, 2022

(51) Int. Cl. H01M 4/62; H01M 4/04

(52) U.S. Cl. CPC H01M 4/622; H01M 4/625; H01M 4/0416

(57) ABSTRACT

A thick cathode is provided. The thick cathode includes a current collector and a coating disposed on the current collector and formed from an electrode composition. The electrode composition includes an active material, a conductive carbon filler, and a binder including carboxylic acid groups on a polymer backbone. The thick cathode has a surface and an energy density of at least 4 milliamp hours per square centimeter of the surface.

### INTRODUCTION

The disclosure generally relates to a battery including a thick cathode and a method for forming the thick cathode.

Batteries, electrochemical cells, or battery cells may include an anode, a cathode, an electrolyte composition, and a separator. A battery may operate in charge mode, receiving electrical energy. A battery may operate in discharge mode, providing electrical energy. A battery may operate through charge and discharge cycles, where the battery first receives and stores electrical energy and then provides electrical energy to a connected system. In vehicles utilizing electrical energy to provide motive force, batteries of the vehicle may be charged, and then the vehicle may navigate for a period of time, utilizing the stored electrical energy to generate motive force.

A battery includes an electrolyte composition which provides lithium-ion conduction paths between the anode and the cathode. The electrolyte is an ionic conductor. The electrolyte is additionally an electronically insulating material.

Hybrid electric and full electric (collectively “electric-drive”) powertrains take on various architectures, some of which utilize a battery system to supply power for one or more electric traction motors.

### SUMMARY

A thick cathode is provided. The thick cathode includes a current collector and a coating disposed on the current collector and formed from an electrode composition. The electrode composition includes an active material, a conductive carbon filler, and a binder including carboxylic acid groups on a polymer backbone. The thick cathode has a surface and an energy density of at least 4 milliamp hours per square centimeter of the surface.

In some embodiments, the binder including the carboxylic acid groups on the polymer backbone includes polyacrylic acid.

In some embodiments, the binder including the carboxylic acid groups on the polymer backbone includes poly(styrenesulfonic acid).

In some embodiments, the binder including the carboxylic acid groups on the polymer backbone includes polymaleic acid.

In some embodiments, the binder including the carboxylic acid groups on the polymer backbone includes polyacrylic acid copolymer.

In some embodiments, the binder including the carboxylic acid groups on the polymer backbone includes poly(styrenesulfonic acid) copolymer.

In some embodiments, the binder including the carboxylic acid groups on the polymer backbone includes polymaleic acid copolymer.

In some embodiments, the active material is present in the coating in an amount of from 70 parts by weight to 99 parts by weight based upon 100 parts by weight of the coating. The conductive carbon filler is present in the coating in an amount of from 0.1 part by weight to 20 parts by weight based upon 100 parts by weight of the coating. The binder is present in the coating in an amount of from 1 part by weight to 20 parts by weight based upon 100 parts by weight of the coating.

In some embodiments, the active material includes nickel, cobalt, manganese, and aluminum (NCMA) and is present in the coating in an amount of 97 parts by weight based upon 100 parts by weight of the coating. The conductive carbon filler is present in the coating in an amount of 1.5 parts by weight based upon 100 parts by weight of the coating. The binder is present in the coating in an amount of 1.5 parts by weight based upon 100 parts by weight of the coating.

According to one alternative embodiment, a method of forming a thick cathode is provided. The method includes mixing a solvent and a conductive carbon filler to form a slurry and mixing together a cathode active material, a binder including carboxylic acid groups on a polymer backbone, and the slurry to form an electrode composition. The method further includes casting the electrode composition onto a current collector and drying the electrode composition to form a coating disposed on the current collector and thereby form the thick cathode. The thick cathode has a surface and an energy density of at least 4 milliamp hours per square centimeter of the surface.

In some embodiments, the cathode active material is present in the coating in an amount of from 70 parts by weight to 99 parts by weight based upon 100 parts by weight of the coating. The conductive carbon filler is present in the coating in an amount of from 0.1 part by weight to 20 parts by weight based upon 100 parts by weight of the coating. The binder is present in the coating in an amount of from 1 part by weight to 20 parts by weight based upon 100 parts by weight of the coating.

In some embodiments, mixing together includes combining the slurry, the cathode active material, and the binder selected from the group consisting of polyacrylic acid, polyacrylic acid copolymer, poly(styrenesulfonic acid), poly(styrenesulfonic acid) copolymer, polymaleic acid, and polymaleic acid copolymer.

In some embodiments, mixing the solvent and the conductive carbon filler to form the slurry includes combining a primary solvent and the conductive carbon filler to form the slurry and combining a secondary solvent and the conductive carbon filler.

In some embodiments, the primary solvent includes N-methyl-2-pyrrolidone.

In some embodiments, the secondary solvent includes water.

In some embodiments, the secondary solvent includes alcohol.

In some embodiments, drying the electrode composition includes heating the electrode composition at a first temperature based upon a vapor pressure of the secondary solvent and, subsequent to heating the electrode composition at the first temperature, continuing heating the electrode composition at a second temperature based upon a vapor pressure of the primary solvent.

In some embodiments, the cathode active material is present in the coating in an amount of from 70 parts by weight to 99 parts by weight based upon 100 parts by weight of the coating. The conductive carbon filler is present in the coating in an amount of from 0.1 parts by weight to 20 parts by weight based upon 100 parts by weight of the coating. The binder is present in the coating in an amount of from 0.1 parts by weight to 20 parts by weight based upon 100 parts by weight of the coating.

In some embodiments, the primary solvent is present in the electrode composition prior to drying in an amount of from 5 parts by weight to 55 parts by weight based upon 100 parts by weight of the electrode composition. The secondary solvent is present in the electrode composition prior to drying in an amount of from 5 parts by weight to 55 parts by weight based upon 100 parts by weight of the electrode composition.

According to one alternative embodiment, a device is provided. The device includes an output component and a battery configured for providing electrical energy to the output component. The battery includes an anode and a thick cathode. The thick cathode includes a current collector and a coating disposed on the current collector and formed from an electrode composition. The electrode composition includes an active material, a conductive carbon filler, and a binder including carboxylic acid groups on a polymer backbone. The thick cathode has a surface and an energy density of at least four milliamp hours per square centimeter of the surface. The battery further includes an electrolyte solution and a separator disposed between the anode and the thick cathode.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery including the disclosed electrode composition, in accordance with the present disclosure;

FIG. 2 schematically illustrates an exemplary device embodied by a vehicle equipped with the battery of FIG. 1, in accordance with the present disclosure;

FIG. 3 is a graph illustrating exemplary test results showing discharge capacity and discharge capacity retention as a function of a number of operation cycles of a first battery including a cathode with a control binder and a second battery including a cathode with the disclosed cathode formed from an electrode composition including a polyacrylic acid (PAA) binder, in accordance with the present disclosure;

FIG. 4 is a flowchart illustrating a method of forming a thick cathode including forming an electrode composition upon a current collector, in accordance with the present disclosure; and

FIG. 5 is a graph illustrating exemplary test results showing discharge capacity and discharge capacity retention as a function of a number of operation cycles of a first battery including a thick cathode created with a single solvent and a second battery including a thick cathode created with a primary solvent and a secondary solvent, in accordance with the present disclosure.

### DETAILED DESCRIPTION

An electrode in a battery may include an anode or a cathode. An electrode includes a current collector constructed of an electrically conductive material, such as copper or aluminum. An electrode further includes a coating disposed upon the current collector and including an active material that is selected based upon an electrochemical reaction that occurs upon the anode and the cathode of the battery. The coating further includes a conductive carbon filler useful to promote conductivity within the coating. Exemplary conductive carbon fillers that may be utilized include graphene nanoplatelets, carbon nanotubes, carbon black, carbon nanofibers, and blends thereof. The coating further includes a binder promoting coherence or stability in the coating.

Electrodes or relatively thin electrodes, excluding a thickness of a corresponding current collector, may include an exemplary thickness of from about 60 micrometers to about 70 micrometers. A relatively thick or a thick electrode may be defined providing increased energy density for the electrode as compared to a relatively thin electrode. In one exemplary embodiment, a thick electrode may include an electrode surface and may be configured for providing at least 4 milliamp hours per square centimeter of the electrode surface. The additional thickness of the electrode including the additional active materials provided within the thickness enables the electrode to deliver the increased energy density. The thickness of the thick electrode may differ based upon active materials in the electrode. In one embodiment, a thick electrode may be defined by the increased energy density it provides.

In one embodiment, a polyvinylidene fluoride (PVDF) binder may be utilized within a coating of an electrode to hold the other components of the coating together. A thick electrode may be difficult to construct. In one embodiment, certain chemical components set forth below are combined with a solvent to create a slurry, that slurry is applied to a current collector as an electrode composition, and the electrode composition is dried, for example, by application of heat. As the electrode composition including a PVDF binder is applied in a relatively thick layer, cracking of the electrode composition and binder migration in the thickness direction during the drying process may occur with substantial regularity as compared to cracking experiences while drying relatively thinner electrode compositions. A cracked and non-uniform coating upon an electrode may decrease conductivity in the coating and may result in decreased durability.

A battery including a thick cathode with a binder including carboxylic acid groups on a polymer backbone is provided to enhance electrode electrochemical performance. A binder including carboxylic acid groups on a polymer backbone may enable formation of a coating on a thick cathode with decreased occurrence of cracking and mitigated binder migration. In one example of a binder including carboxylic acid groups on a polymer backbone, a polyacrylic acid (PAA) or its copolymer may be utilized as a binding agent. In another example of a binder including carboxylic acid groups on a polymer backbone, poly(styrenesulfonic acid) or its copolymer may be utilized as a binding agent. In another example of a binder including carboxylic acid groups on a polymer backbone, polymaleic acid or its copolymer may be utilized as a binding agent. Use of one or more these binders including carboxylic acid groups on a polymer backbone in a coating of a thick cathode may facilitate enhanced stability of the electrode slurry and improved binder/active materials interaction, favorably impacting the electrode uniformity, thus resulting in improved cycle life performance. A battery including an electrode formed with a binder including carboxylic acid groups on a polymer backbone and a conductive filler such as carbon nanotubes may be utilized to achieve complex mechanical and electrical networks within the electrode.

A thick cathode is provided. The thick cathode includes a current collector and a coating disposed on the current collector and formed from an electrode composition. The electrode composition includes an active material, a conductive carbon filler, and a binder including carboxylic acid groups on a polymer backbone. The thick cathode has a surface and an energy density of at least 4 milliamp hours per square centimeter of the surface.

The binder including the carboxylic acid groups on the polymer backbone may include polyacrylic acid.

The binder including the carboxylic acid groups on the polymer backbone may include poly(styrenesulfonic acid).

The binder including the carboxylic acid groups on the polymer backbone may include polymaleic acid.

The binder including the carboxylic acid groups on the polymer backbone may include polyacrylic acid copolymer.

The binder including the carboxylic acid groups on the polymer backbone may include poly(styrenesulfonic acid) copolymer.

The binder including the carboxylic acid groups on the polymer backbone may include polymaleic acid copolymer.

The active material may be present in the coating in an amount of from 70 parts by weight to 99 parts by weight based upon 100 parts by weight of the coating (the electrode composition after drying). The conductive carbon filler may be present in the coating in an amount of from 0.1 part by weight to 20 parts by weight based upon 100 parts by weight of the coating. The binder may be present in the coating in an amount of from 1 part by weight to 20 parts by weight based upon 100 parts by weight of the coating.

The active material may include nickel, cobalt, manganese, and aluminum (NCMA) and may be present in the coating in an amount of 97 parts by weight based upon 100 parts by weight of the coating. The conductive carbon filler may be present in the coating in an amount of 1.5 parts by weight based upon 100 parts by weight of the coating. The binder may be present in the coating in an amount of 1.5 parts by weight based upon 100 parts by weight of the coating.

According to one alternative embodiment, a device is provided. The device includes an output component and a battery configured for providing electrical energy to the output component. The battery includes an anode and a thick cathode. The thick cathode includes a current collector and a coating disposed on the current collector and formed from an electrode composition. The electrode composition includes an active material, a conductive carbon filler, and a binder including carboxylic acid groups on a polymer backbone. The thick cathode has a surface and an energy density of at least four milliamp hours per square centimeter of the surface. The battery further includes an electrolyte solution and a separator disposed between the anode and the thick cathode.

A degree of ionization describes a proportion of neutral particles in a solution that are ionized into charged particles. The degree of ionization of the binder including carboxylic acid groups on a polymer backbone is dependent on the pH of the solution. A binder including carboxylic acid groups on a polymer backbone with low pH includes low ionization. As pH of the binder including carboxylic acid groups on a polymer backbone increases, so does the ionization.

A weight average molecular weight describes a content or a mass of a molecule. A molecular weight of a simple molecule may be stated. Determining a molecular weight of a polymer is more complex, as polymer molecules may include repeating units. As polymers grow in length, drag and intermolecular attraction forces increase, thereby increasing viscosity of a solution including the polymer molecules.

In one embodiment, a binder including carboxylic acid groups on a polymer backbone with a low degree of ionization at multiple molecular weights may be used to improve slurry dispersion and enhance cycle life performance of the electrode.

A slurry may include an electrode composition including a binder including carboxylic acid groups on a polymer backbone to enhance an electrode slurry stability and enhance an electrode structure. An addition of the binder creates an encapsulation of the other material particles of the electrode coating. This encapsulation enables excellent suspension and cohesion between the particles to improve final electrode adhesion.

Adjustment of the molecular weight of the binder including carboxylic acid groups on a polymer backbone may impact slurry rheology. Table 1 is provided describing an exemplary effect of number average molecular weight on resulting viscosity, wherein the binder including carboxylic acid groups on a polymer backbone is embodied as PAA.

TABLE 1

| | Solid | Viscosity, mPA · s | | |
|---|---|---|---|---|
| Slurry Binder | Content | @20 s⁻¹ | @50 s⁻¹ | (@100 s⁻¹ |
| PVDF | 71.5% | 11585 | 6724 | 4663 |
| PAA @ MW 450K | 71.5% | 15201 | 10011 | 5581 |
| PAA @ MW 3 Million | 52.5% | 7118 | 4096 | 2637 |

Three slurry binders are described, a first including PVDF, a second including PAA with an average molecular weight of 450,000, and a third including PAA with an average molecular weight of 3 million. Viscosity of the slurry may be tailored by using different molecular weight polymers. If the viscosity of the slurry is too low, the resulting coating is more likely to crack during the drying process. If the viscosity of the slurry is too high, the slurry may be difficult to extrude through a slot die, reducing the coating speed and sacrificing the coating quality.

An exemplary electrode composition is provided including an active material present in the slurry in an amount from 70 parts by weight to 99 parts by weight based upon 100 parts by weight of the coating after drying. The electrode composition further includes a conductive carbon filler present in the slurry in an amount from 0.1 parts by weight to 20 parts by weight based upon 100 parts by weight of the coating after drying. The electrode composition further includes a binder present in the slurry in an amount from 1 part by weight to 20 parts by weight based upon 100 parts by weight of the coating after drying.

The disclosed electrode composition of the slurry includes the active material present in a coating of the electrode in an amount from 70 parts by weight to 99 parts by weight based upon 100 parts by weight of the coating after drying. Additionally, the conductive carbon filler is present in the coating in an amount from 0.1 parts by weight to 20 parts by weight based upon 100 parts by weight of the coating after drying. Additionally, the binder is present in the coating in an amount from 1 part by weight to 20 parts by weight based upon 100 parts by weight of the coating after drying.

The active materials may include lithium manganese oxide (LMO), LiNiₓCo_{y}Mn_{z}Al_{(1-x-y-z)}O₂ (NCMA), lithium nickel manganese cobalt oxide (NMC), olivine LiMnₓFe(1-x)PO₄ (LMFP), or a blend thereof. The conductive carbon filler may include graphene nanoplatelets, carbon nanotubes, carbon black, carbon nanofibers or blends thereof.

In one embodiment, the disclosed electrode composition of the slurry includes the active material including NCMA and present in a coating of the electrode in an amount 97 parts by weight based upon 100 parts by weight of the coating after drying. Additionally, the conductive carbon filler is present in the coating in an amount of 1.5 parts by weight based upon 100 parts by weight of the coating after drying. Additionally, the binder is present in the coating in an amount of 1.5 parts by weight based upon 100 parts by weight of the coating after drying.

Binders with different molecular weights may be utilized. For example, the electrode composition may include a mixture of binders with molecular weights of 250,000, 450,000, and 3 million. The electrode composition may include a first binder with a first molecular weight and a second binder with a second molecular weight. The binder with the first molecular weight may be present in the electrode composition in a ratio ranging from 2 parts of the binder with the first molecular weight to 8 parts of the binder with the second molecular weight to 8 parts of the binder with the first molecular weight to 2 parts of the binder with the second molecular weight.

A solvent is utilized in combination with the active material, the conductive carbon filler, and the binder to create a slurry useful to create a coating of an electrode. In one embodiment, N-methyl-2-pyrrolidone (NMP) may be utilized as a solvent. In one embodiment, a plurality of solvents or a primary solvent and a co-solvent may be utilized to create a thick cathode. In one embodiment, NMP may be utilized as the primary solvent and one of water or alcohol, for example, isopropanol alcohol, may be utilized as the co-solvent. Water or alcohol may be selected based upon whether the components of the coating being created are tolerant of being mixed with either co-solvent. For example, NCMA in some embodiments may not be mixed with water. Use of a plurality of solvents, in particular, solvents with different vapor pressures or evaporation rates, may be useful in utilizing a slurry to create a coating of an electrode. Benefits of using a plurality of solvents include reducing slurry viscosity for increased electrode coating speed and enhanced slurry stability once the solvent with the lower vapor pressure is quickly evaporated in a dryer. Further, an excellent electrochemical network and pore structure may be created in the cathode, which improves cycle performance. Pore size may be varied by drying temperature. Further, excellent slurry uniformity and binder distribution in the cathode is observed when the slurry includes two solvents with different vapor pressures.

An exemplary electrode composition taking advantage of a plurality of solvents is provided including an active material present in the electrode composition in an amount from 70 parts by weight to 99 parts by weight based upon 100 parts by weight of the electrode composition after drying. The electrode composition further includes a conductive carbon filler present in the electrode composition in an amount from 0.1 parts by weight to 20 parts by weight based upon 100 parts by weight of the electrode composition after drying. The electrode composition further includes a binder present in the electrode composition in an amount from 0.1 part by weight to 20 parts by weight based upon 100 parts by weight of the electrode composition after drying.

The primary solvent may be present in the electrode composition prior to drying in an amount of from 5 parts by weight to 55 parts by weight based upon 100 parts by weight of the electrode composition. The secondary solvent may be present in the electrode composition prior to drying in an amount of from 5 parts by weight to 55 parts by weight based upon 100 parts by weight of the electrode composition. In some embodiments, tertiary and quaternary solvents may additionally be present.

According to one alternative embodiment, a method of forming a thick cathode is provided. The method includes mixing a solvent and a conductive carbon filler to form a slurry and mixing together a cathode active material, a binder including carboxylic acid groups on a polymer backbone, and the slurry to form an electrode composition. The method further includes casting the electrode composition onto a current collector and drying the electrode composition to form a coating disposed on the current collector and thereby form the thick cathode. The thick cathode has a surface and an energy density of at least 4 milliamp hours per square centimeter of the surface.

The cathode active material may be present in the coating in an amount of from 70 parts by weight to 99 parts by weight based upon 100 parts by weight of the coating. The conductive carbon filler may be present in the coating in an amount of from 0.1 part by weight to 20 parts by weight based upon 100 parts by weight of the coating. The binder may be present in the coating in an amount of from 1 part by weight to 20 parts by weight based upon 100 parts by weight of the coating.

Mixing together may include combining the slurry, the cathode active material, and the binder selected from the group consisting of polyacrylic acid, polyacrylic acid copolymer, poly(styrenesulfonic acid), poly(styrenesulfonic acid) copolymer, polymaleic acid, and polymaleic acid copolymer.

Mixing the solvent and the conductive carbon filler to form the slurry may include combining a primary solvent and the conductive carbon filler to form the slurry and combining a secondary solvent and the conductive carbon filler.

The primary solvent may include N-methyl-2-pyrrolidone.

The secondary solvent may include water.

The secondary solvent may include alcohol.

Drying the electrode composition may include heating the electrode composition at a first temperature based upon a vapor pressure of the secondary solvent and, subsequent to heating the electrode composition at the first temperature, continuing heating the electrode composition at a second temperature based upon a vapor pressure of the primary solvent.

The cathode active material may be present in the coating in an amount of from 70 parts by weight to 99 parts by weight based upon 100 parts by weight of the coating. The conductive carbon filler may be present in the coating in an amount of from 0.1 parts by weight to 20 parts by weight based upon 100 parts by weight of the coating. The binder may be present in the coating in an amount of from 0.1 parts by weight to 20 parts by weight based upon 100 parts by weight of the coating.

The primary solvent may be present in the electrode composition prior to drying in an amount of from 5 parts by weight to 55 parts by weight based upon 100 parts by weight of the electrode composition. The secondary solvent may be present in the electrode composition prior to drying in an amount of from 5 parts by weight to 55 parts by weight based upon 100 parts by weight of the electrode composition.

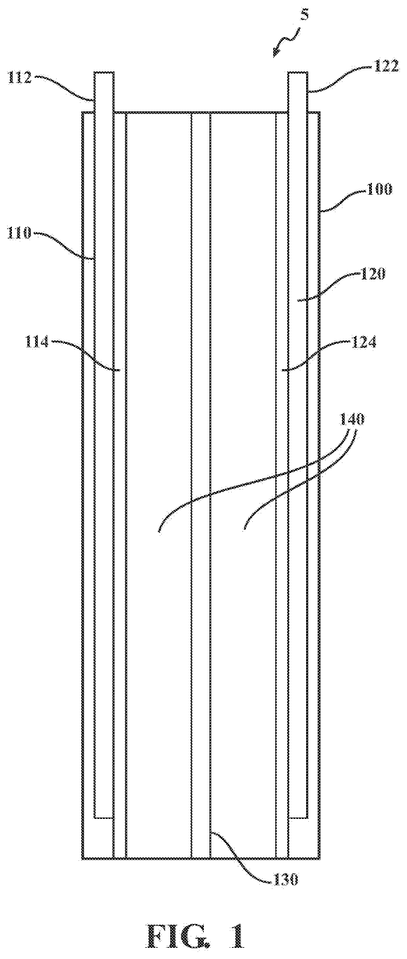

Referring now to the drawings, wherein like reference numbers refer to like features throughout the several views, FIG. 1 schematically illustrates an exemplary battery 100, including an anode 110, a thick cathode 120, a separator 130, and an electrolyte composition 140. A battery system 5 or a battery device may be defined to include one or more batteries 100. The battery 100 enables converting electrical energy into stored chemical energy in a charging cycle, and the battery 100 enables converting stored chemical energy into electrical energy in a discharging cycle. A negative current collector 112 is illustrated connected to the anode 110, and a positive current collector 122 is illustrated connected to the thick cathode 120. A coating 114 is illustrated upon the anode 110. A coating 124 is illustrated upon the thick cathode 120. The separator 130 is operable to separate the anode 110 from the thick cathode 120 and to enable ion transfer through the separator 130. The electrolyte composition 140 is a liquid or gel that provides a lithium-ion conduction path between the anode 110 and the thick cathode 120.

The anode 110 may be constructed of lithium, graphite, silicon, SiOₓ, Li_{y}SiOₓ, Si/C, or a blend of two or more of these materials. The thick cathode 120 may be constructed of a LMO, NCMA, NMC, LMFP, or a blend of two or more of these materials.

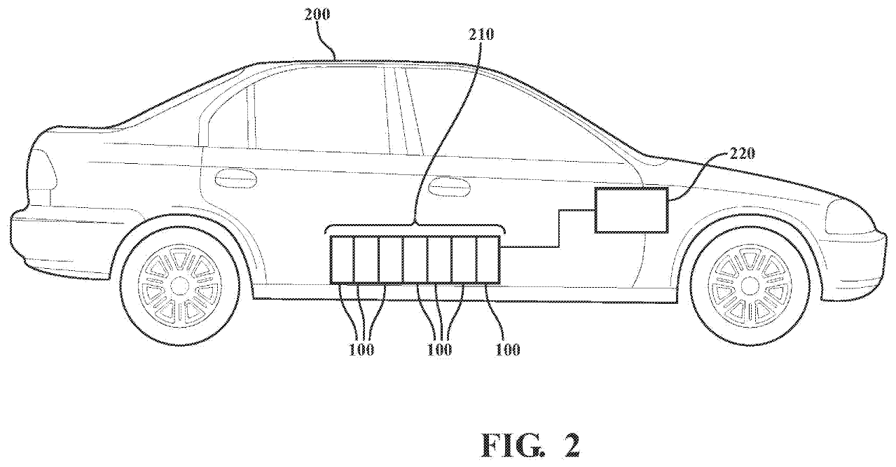

The battery 100 may be utilized in a wide range of applications and powertrains. FIG. 2 schematically illustrates an exemplary device 200, e.g., a battery electric vehicle (BEV), including a battery 210 that includes a plurality of batteries 100. The plurality of batteries 100 may be connected in various combinations, for example, with a portion being connected in parallel and a portion being connected in series, to achieve goals of supplying electrical energy at a desired voltage. The battery 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

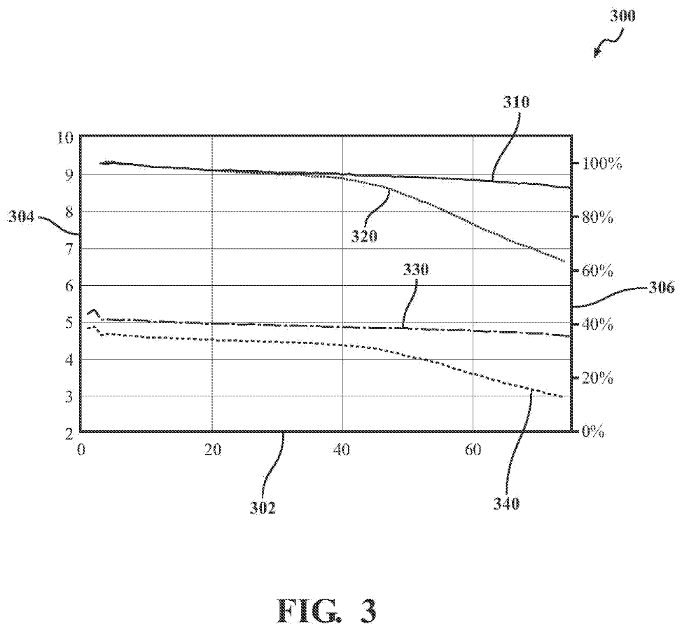

FIG. 3 is a graph 300 illustrating exemplary test results showing discharge capacity and discharge capacity retention as a function of a number of operation cycles of a first battery including a cathode with a control binder and a second battery including a cathode with the disclosed cathode electrode composition including a PAA binder. A first vertical axis 304 is illustrated describing a discharge capacity in milliamp hours per square centimeter. A second vertical axis 306 is illustrated describing a discharge capacity retention as a percentage of an original discharge capacity. A horizontal axis 302 is illustrated including a number of operation cycles, each including a charging cycle and a discharging cycle. The batteries each include a cathode including a blend of NCMA and LMO present in 97 parts by weight as compared to 100 parts by weight of a total weight of a coating of the cathode. Plots 320 and 340 illustrate operation of a first battery including a PVDF binder, wherein an NMP solvent is used to create the coating upon the cathode of the first battery. Plots 310 and 330 illustrate operation of a second battery including a PAA binder with a molecular weight of 450,000, wherein an NMP solvent is used to create the coating upon the cathode of the second battery. Plot 320 illustrates the first battery through the illustrated operation cycles, illustrating discharge capacity retention according to vertical axis 306. Plot 310 illustrates the second battery through the illustrated operation cycles, illustrating discharge capacity retention according to vertical axis 306. Plot 340 illustrates the first battery through the illustrated operation cycles, illustrating discharge capacity according to vertical axis 304. Plot 330 illustrates the first battery through the illustrated operation cycles, illustrating discharge capacity according to vertical axis 304. One may see that use of the PAA binder in the second battery including the NCMA/LMO blended cathode shows improved capacity retention as compared to the first battery including the PVDF binder.

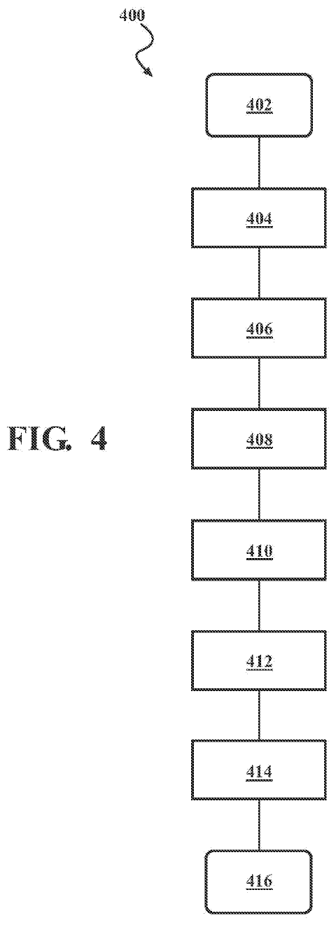

FIG. 4 is a flowchart illustrating a method 400 for forming a coating upon a current collector to create a thick cathode 120 illustrated in FIG. 1. The method 400 starts at step 402. At step 404, a conductive carbon filler is mixed with a solvent to form the slurry. Mixing the conductive carbon filler and the solvent may be performed for from 2 minutes to 10 minutes, e.g., for 5 minutes. When a plurality of solvents is being utilized to create the cathode, step 404 may include adding the primary solvent. At step 406, a cathode active material may be mixed with the slurry from the step 404. This mixture including the cathode active material may be further mixed for from 2 minutes to 10 minutes, e.g., for 5 minutes. At step 408, a binder, for example, including PAA, may be mixed with the mixture from the step 406. Binders with different molecular weights may be simultaneously added. This mixture including the binder may be further mixed for from 2 minutes to 10 minutes, e.g., for 5 minutes. At step 410, additional solvent or a secondary solvent may be mixed with the mixture from the step 408. This mixture including the additional solvent may be further mixed for from 2 minutes to 10 minutes, e.g., for 5 minutes. At step 412, the mixture from the fourth step is applied to or cast upon a current collector to form a coating upon the current collector. In one embodiment, a humidity chamber may be utilized in step 412. At step 414, the current collector including the coating is dried. The drying may include exposure to temperatures ranging from 50° C. to 120° C. in an exemplary oven for from 1 minute to 5 hours. When a plurality of solvents is present in the slurry, a plurality of drying steps at different temperatures may be utilized. Once the current collector and the coating are dried, the electrode is complete, and the method 400 ends at step 416. A number of additional or alternative method steps are envisioned, and the disclosure is not intended to be limited to the examples provided herein.

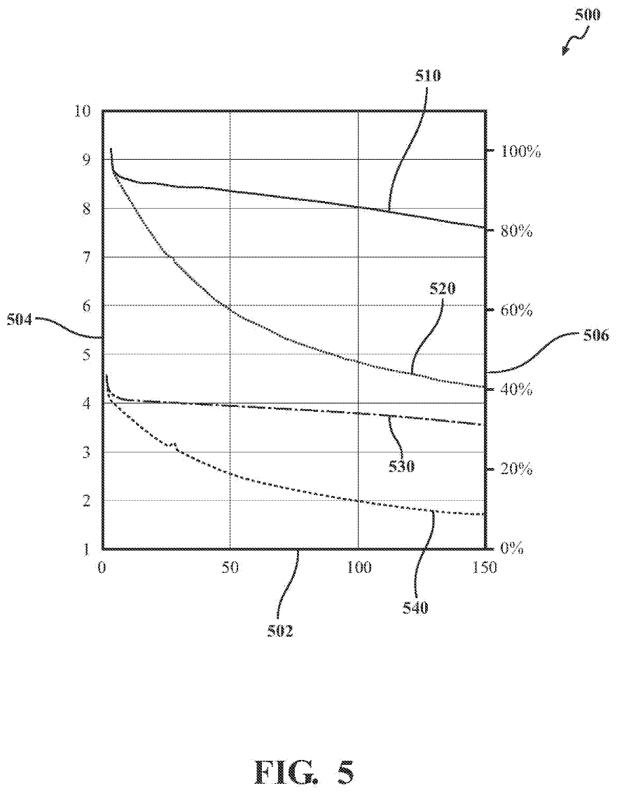

FIG. 5 is a graph 500 illustrating exemplary test results showing discharge capacity and discharge capacity retention as a function of a number of operation cycles of a first battery including a cathode created with a single solvent and a second battery including a cathode created with a primary solvent and a secondary solvent. A first vertical axis 504 is illustrated describing a discharge capacity in milliamp hours per square centimeter. A second vertical axis 506 is illustrated describing a discharge capacity retention as a percentage of an original discharge capacity. A horizontal axis 502 is illustrated including a number of operation cycles, each including a charging cycle and a discharging cycle. The batteries each include a cathode including a blend of LMO and a conductive carbon filler (Super P® (SP) which is commercially available through Imerys Graphite & Carbon Switzerland SA, Bodio, Switzerland) present in 97 parts by weight based upon 100 parts by weight of a total weight of a coating of the cathode. Plots 520 and 540 illustrate operation of a first battery including a PAA binder, wherein an NMP solvent is used to create the coating upon the cathode of the first battery. Plots 510 and 530 illustrate operation of a second battery including a PAA binder wherein a plurality of solvents are used to create the coating upon the cathode of the second battery (an NMP solvent is used as a primary solvent and water is used as a secondary solvent.). Plot 520 illustrates the first battery through the illustrated operation cycles, illustrating discharge capacity retention according to vertical axis 506. Plot 510 illustrates the second battery through the illustrated operation cycles, illustrating discharge capacity retention according to vertical axis 506. Plot 540 illustrates the first battery through the illustrated operation cycles, illustrating discharge capacity according to vertical axis 504. Plot 530 illustrates the first battery through the illustrated operation cycles, illustrating discharge capacity according to vertical axis 504. One may see that utilizing a plurality of solvents to create the cathode of the second battery according to the disclosure shows improved capacity retention as compared to utilizing the single solvent to create the cathode of the first battery.

While the best modes for carrying out the disclosure have been described in detail, those familiar with the art to which this disclosure relates will recognize various alternative designs and embodiments for practicing the disclosure within the scope of the appended claims.

What is claimed is:

1. A thick cathode comprising:
a current collector; and
a coating disposed on the current collector and formed from an electrode composition including:
an active material;
a conductive carbon filler; and
a binder including carboxylic acid groups on a polymer backbone;
wherein the thick cathode has a surface and an energy density of at least 4 milliamp hours per square centimeter of the surface.

2. The thick cathode of claim 1, wherein the binder including the carboxylic acid groups on the polymer backbone includes polyacrylic acid.

3. The thick cathode of claim 1, wherein the binder including the carboxylic acid groups on the polymer backbone includes poly(styrenesulfonic acid).

4. The thick cathode of claim 1, wherein the binder including the carboxylic acid groups on the polymer backbone includes polymaleic acid.

5. The thick cathode of claim 1, wherein the binder including the carboxylic acid groups on the polymer backbone includes polyacrylic acid copolymer.

6. The thick cathode of claim 1, wherein the binder including the carboxylic acid groups on the polymer backbone includes poly(styrenesulfonic acid) copolymer.

7. The thick cathode of claim 1, wherein the binder including the carboxylic acid groups on the polymer backbone includes polymaleic acid copolymer.

8. The thick cathode of claim 1, wherein the active material is present in the coating in an amount of from 70 parts by weight to 99 parts by weight based on 100 parts by weight of the coating;
wherein the conductive carbon filler is present in the coating in an amount of from 0.1 part by weight to 20 parts by weight based on 100 parts by weight of the coating; and
wherein the binder is present in the coating in an amount of from 1 part by weight to 20 parts by weight based on 100 parts by weight of the coating.

9. The thick cathode of claim 1, wherein the active material includes nickel, cobalt, manganese, and aluminum (NCMA) and is present in the coating in an amount of 97 parts by weight based upon 100 parts by weight of the coating;
wherein the conductive carbon filler is present in the coating in an amount of 1.5 parts by weight based upon 100 parts by weight of the coating; and
wherein the binder is present in the coating in an amount of 1.5 parts by weight based upon 100 parts by weight of the coating.

10. A method of forming a thick cathode, the method comprising:
mixing a solvent and a conductive carbon filler to form a slurry;
mixing together:
a cathode active material;
a binder including carboxylic acid groups on a polymer backbone; and
the slurry to form an electrode composition;
casting the electrode composition onto a current collector; and
drying the electrode composition to form a coating disposed on the current collector and thereby form the thick cathode;
wherein the thick cathode has a surface and an energy density of at least 4 milliamp hours per square centimeter of the surface.

11. The method of claim 10, wherein the cathode active material is present in the coating in an amount of from 70 parts by weight to 99 parts by weight based upon 100 parts by weight of the coating;
wherein the conductive carbon filler is present in the coating in an amount of from 0.1 part by weight to 20 parts by weight based upon 100 parts by weight of the coating; and
wherein the binder is present in the coating in an amount of from 1 part by weight to 20 parts by weight based upon 100 parts by weight of the coating.

12. The method of claim 10, wherein mixing together includes combining the slurry, the cathode active material, and the binder selected from the group consisting of polyacrylic acid, polyacrylic acid copolymer, poly(styrenesulfonic acid), poly(styrenesulfonic acid) copolymer, polymaleic acid, and polymaleic acid copolymer.

13. The method of claim 10, wherein mixing the solvent and the conductive carbon filler to form the slurry includes:
combining a primary solvent and the conductive carbon filler to form the slurry; and
combining a secondary solvent and the conductive carbon filler.

14. The method of claim 13, wherein the primary solvent includes N-methyl-2-pyrrolidone.

15. The method of claim 13, wherein the secondary solvent includes water.

16. The method of claim 13, wherein the secondary solvent includes alcohol.

17. The method of claim 13, wherein drying the electrode composition includes heating the electrode composition at a first temperature based upon a vapor pressure of the secondary solvent and, subsequent to heating the electrode composition at the first temperature, continuing heating the electrode composition at a second temperature based upon a vapor pressure of the primary solvent.

18. The method of claim 13, wherein the cathode active material is present in the coating in an amount of from 70 parts by weight to 99 parts by weight based upon 100 parts by weight of the coating;
wherein the conductive carbon filler is present in the coating in an amount of from 0.1 parts by weight to 20 parts by weight based upon 100 parts by weight of the coating; and
wherein the binder is present in the coating in an amount of from 0.1 parts by weight to 20 parts by weight based upon 100 parts by weight of the coating.

19. The method of claim 18, wherein the primary solvent is present in the electrode composition prior to drying in an amount of from 5 parts by weight to 55 parts by weight based upon 100 parts by weight of the electrode composition; and
wherein the secondary solvent is present in the electrode composition prior to drying in an amount of from 5 parts by weight to 55 parts by weight based upon 100 parts by weight of the electrode composition.

20. A device comprising:
an output component; and
a battery configured for providing electrical energy to the output component, the battery including:
an anode;
a thick cathode including:
a current collector; and
a coating disposed on the current collector and formed from an electrode composition including:
an active material;
a conductive carbon filler; and
a binder including carboxylic acid groups on a polymer backbone;
wherein the thick cathode has a surface and an energy density of at least four milliamp hours per square centimeter of the surface;
an electrolyte solution; and
a separator disposed between the anode and the thick cathode.
